(19) United States
(12) Patent Application Publication
(10) Pub. No.: US 2004/0069900 A1
(43) Pub. Date: Apr. 15, 2004

(54) Reverse velocity, differential pressure, hydraulic, travel from earth to outer space and back

(76) Inventors: Jimmy T. Hawthorne, Tavares, FL (US); Lynn A. Buckner, Chickamayga, GA (US)

Correspondence Address: Lynn A. Buckner, P. O. Box 609, Chickamauga, GA, 30707, US

(21) Appl. No.: 10/612,259

(22) Filed: Jul. 3, 2003

Related U.S. Application Data
(60) Provisional application No. 60/394,465, filed on Jul. 9, 2002.
(60) Provisional application No. 60/475,952, filed on Jun. 5, 2003.

(51) Int. Cl. B64C 27/00

(52) U.S. Cl. 244/24; 244/62

(57) ABSTRACT

A means to use the natural forces of nature when correctly understood and applied to move personnel and objects from Earth's surface to outer space using a conduit with valves, access air locks, support & stabilizing means, to redirect and throttle naturally occurring forces. A magnetic field may also be used. The magnetic field may be applied parallel or longitudinal to the conduit. “Outer space lake substance” Redirecting Means may be utilized with the conduit in order to assist in moving a vessel with personnel or objects to or from outer space.

### BACKGROUND OF THE INVENTION

Conventional thinking teaches that the Earth has a “gravitational pull” which “pulls” objects toward the center of the Earth. It is taught that to move a tangible object from the Earth's surface to outer space requires a powered thrust rocket craft.

It is therefore an object of the present invention to provide new teaching and understanding of the phenomenon of “gravity” and a means to use the new teachings of “gravity” to transport objects and personnel from Earth's surface to outer space without relying solely on a powered thrust rocket craft.

It is yet another objective of the present invention to provide new teaching and understanding of the phenomenon of “magnetic fields”, “magnetism”, the flow of electrical forces, their relationship to “gravity”, tide, planet location, planet movements and a means to use the above mentioned technology to power a vessel which may move objects or personnel from Earth's surface to outer space.

### BRIEF SUMMARY OF THE INVENTION

The above described needs and others are met by a conduit 15 having a first end located in proximity to the Earth's 2 surface and a second end located in proximity to outer space. The conduit has a means of anchoring it to Earth's 2 surface, a means to support 26 it or float 22 it in Earth's atmosphere 20, means to counteract the forces of weather 23,24 & 25, means to open and close either end of said conduit 30 & 31, a vessel 27 to be located within said conduit 15, means to transport said vessel 27 up or down said conduit 15, means to load objects 29 or personnel 28 into or remove from said vessel 27, means to allow the higher pressure atmosphere 16 at Earth's 2 surface to enter the lower end of said conduit 15 below said capsule 27. A seal 35 between the vessel 27 and the inner wall of said conduit 15 cause the capsule to be moved upward as the higher pressure of Earth's surface atmosphere 16 is pushed upward in the conduit 15 toward the low pressure 17 of the outer space 1 end of the conduit. Bypass valve 34 means throttle the ascent or decent of the vessel up or down the inside of the conduit 15.

Magnetic means 33, magnetic fields 6, “OSLS” redirected flow means 38, electron directing means 36 or reverse gravity 37 means may be used to assist in moving the vessel up or down the inside of said conduit 15.

Said conduit 15 may extend only partially to outer space and be used similar to that of a rifle barrel or chimney or potato gun to launch a vessel 27 into outer space 1. Multiple stages of conduit may work in communication to each other to accomplish a greater task.

### BRIEF DESCRIPTION OF THE DRAWINGS

FIG. 1—Is a drawing showing the planet Earth 2, its atmosphere 20 and illustrates the relationship of volume of atmosphere 3,4&5 closer to or further away from Earth's 2 surface. It also illustrates the increased density of the atmosphere 2 and outer space lake substance 1 as it travels toward the Earth's 2 surface.

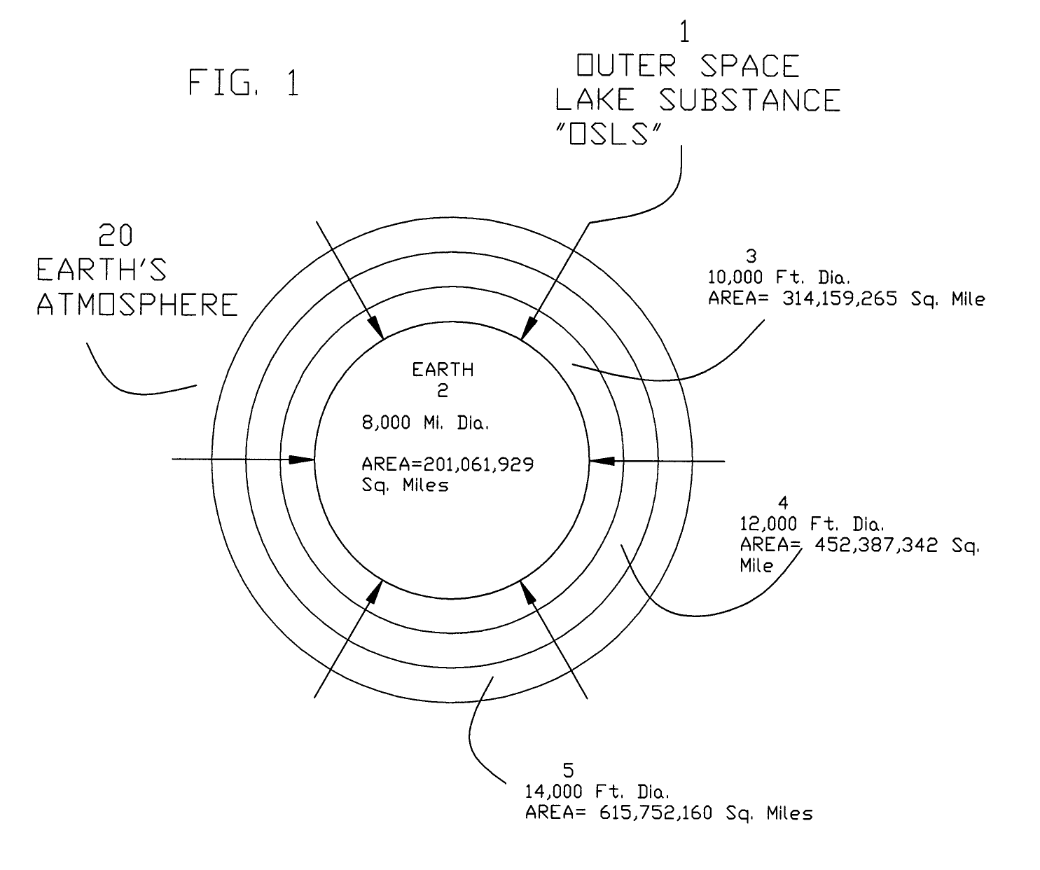

FIG. 2—Is a drawing showing the planet Earth 2, the flow of “outer space lake substance” 1 to Earth 2 from outer space and how the “OSLS” 1 creates a flow described as a magnetic field 6. The north pole 7 & south pole 8 of the magnetic field 6 are shown.

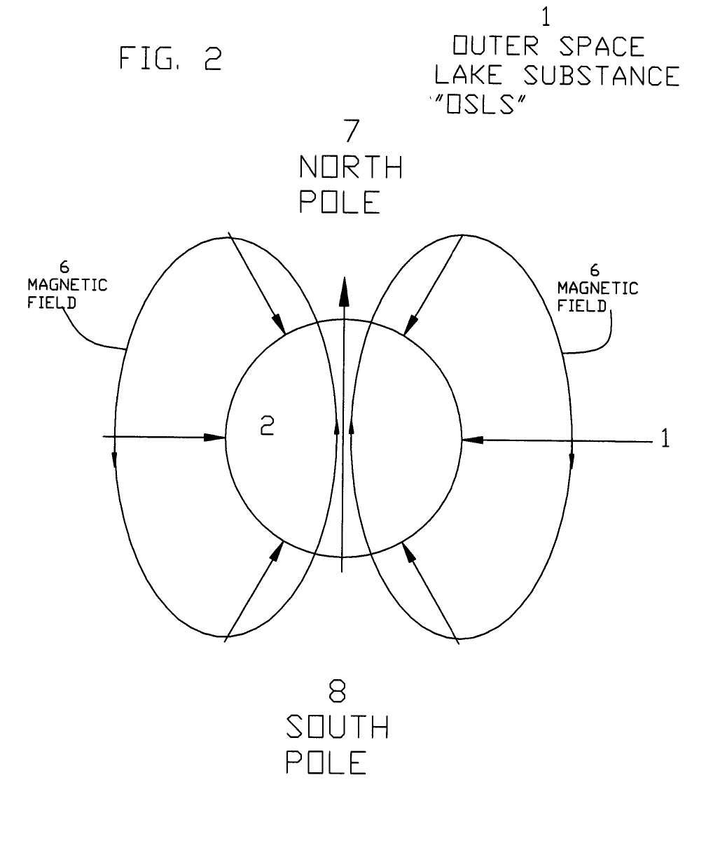

FIG. 3—Is similar to FIG. 2 except it shows the orbital path 14 of the Earth 2 in relationship to the sun 12, the thrust angle of the Earth 2 due to the flow of “OSLS” 1 the rotational rate 9 of the Earth 2 as caused by “OSLS” 1 flow, the sun's light force 13 and the moon 10 and its travel orbit 11 in relation to the Earth.

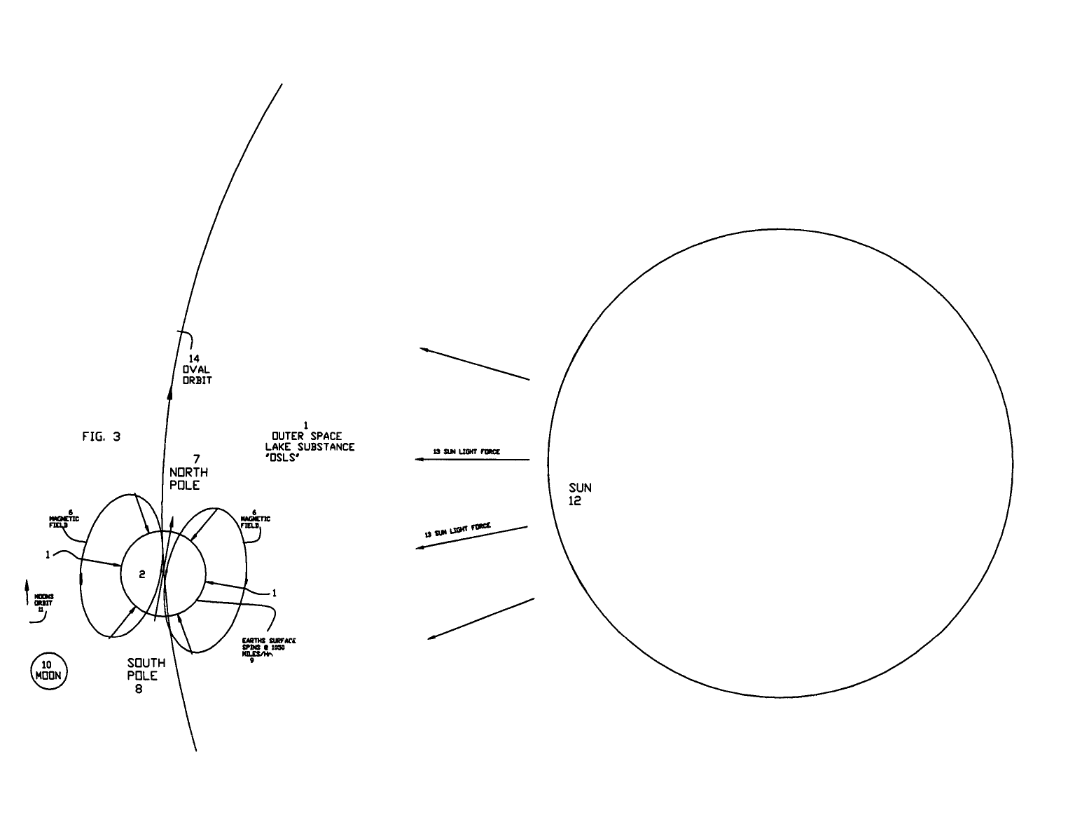

FIG. 4—Is similar to FIG. 1 and 2 except that the conduit 15 is shown starting near Earth's surface and continuing towards outer space. In this drawing the conduit 15 is used similar to two potato guns with high-pressure atmospheric air 16 entering the lower end of the conduit 15 thus pushing vessel 27 ahead of it as the pressurized air 16 rushes toward equilibrium at the low pressure outer space end 17 of conduit 15. Vessel 27 gains velocity as it moves up the inside of conduit 15 thus it is thrust into the outer space lake of substance being relatively free of atmospheric resistance and free of the flow velocity of “OSLS” rushing to the Earth for consumption into another dimension.

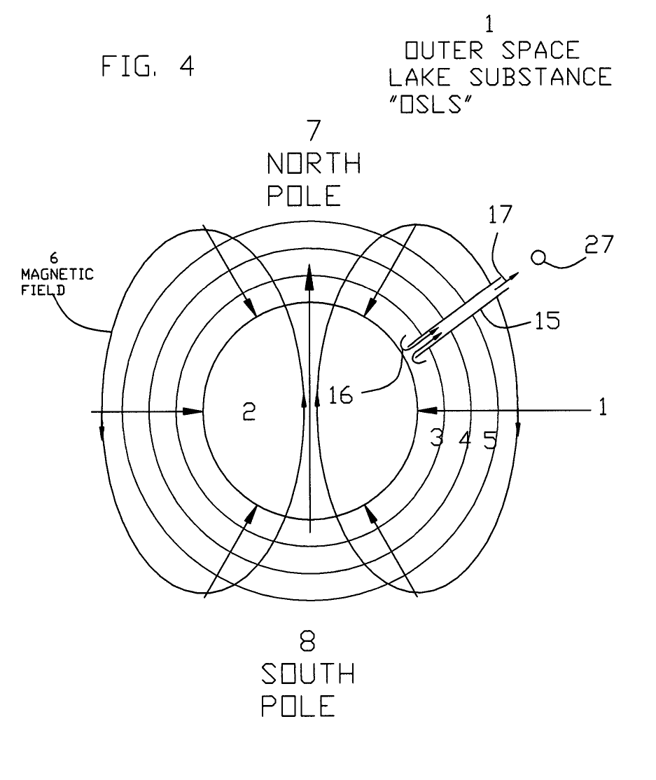

FIG. 5—Illustrates how the moon 10 shields the flow of“OSLS” 1 to the Earth 2 thus creating a low pressure 18 of “OSLS” 1 in the moon's shadow 18. The Ocean 19 is shown being pushed toward the moon because of the higher-pressure concentration of “OSLS” 1 outside of the moon's “OSLS” shadow 18.

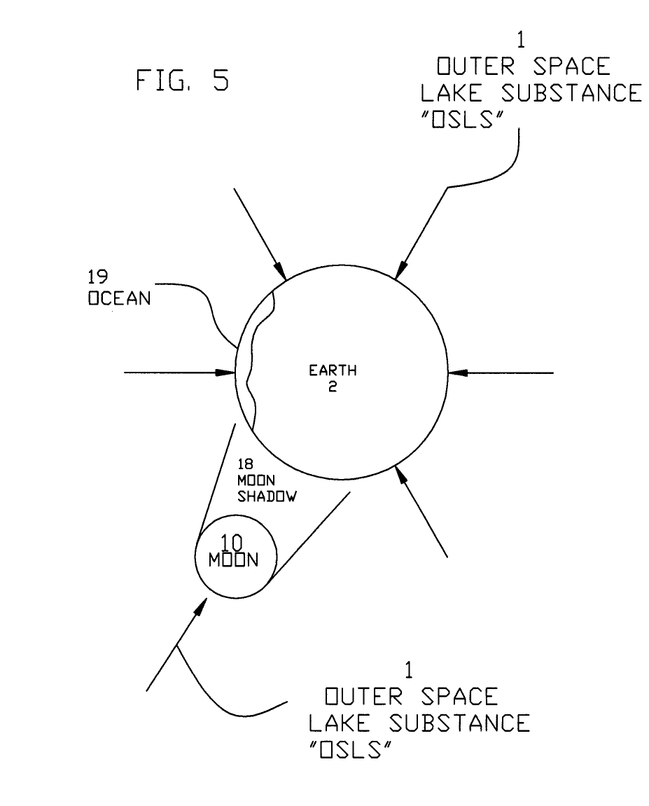

FIG. 6—Illustrates a vacuum conduit 15 secured to Earth 2 by an anchor means 26. High-pressure atmosphere 16 near Earth's 2 surface enters a first end of conduit 15 through valve orifice 30, a lighter than air vessel 32 is docked at the inlet of conduit 15. Vessel 27 is shown containing objects 29 and personnel 28. Vessel 27 is sealed 35 to the walls of conduit 15. A throttle valve 34 controls the speed of vessel 27 upward or downward by throttling the bypass atmosphere 16. Thrust stabilizing 23, aerodynamic stabilizers 24 and directional stabilizers 25 align and off set weather forces. An outer covering 21 creates a void 22 between it and the conduit 15. This void 22 may be pressurized with a lighter than air substance to lift and/or support conduit 15. A valve orifice 31 controls access between the inside of conduit 15 and the “OSLS” 1.

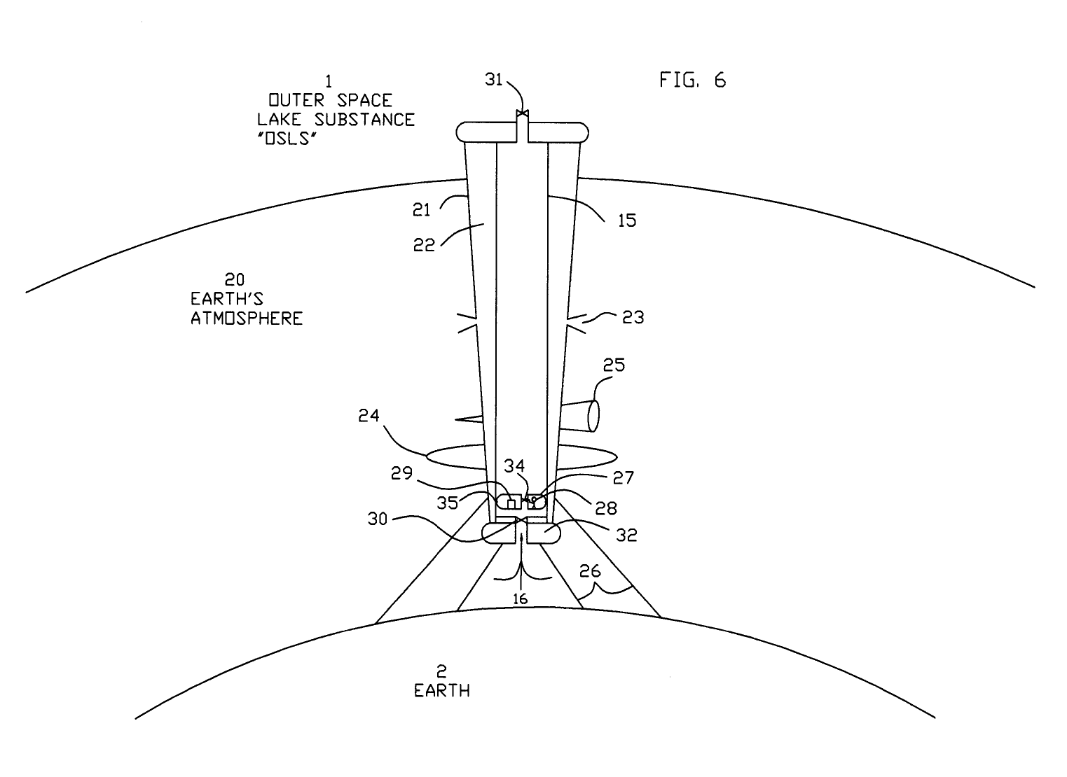

FIG. 7—Illustrates the redirection of “OSLS” 1, the use of magnetism, magnetic forces, and/or electron flow to assist in the movement of a vessel 27 through conduit 15. One or more Electron Directing Means 36, Reverse Gravity Directing Means 37 or “OSLS” Redirecting Means 38 may be utilized on or along the conduit 15. Vessel 27 with its contacts 29 and 28 are shown being thrusted into outer space using atmospheric pressure differential 16 and electron flow 33.

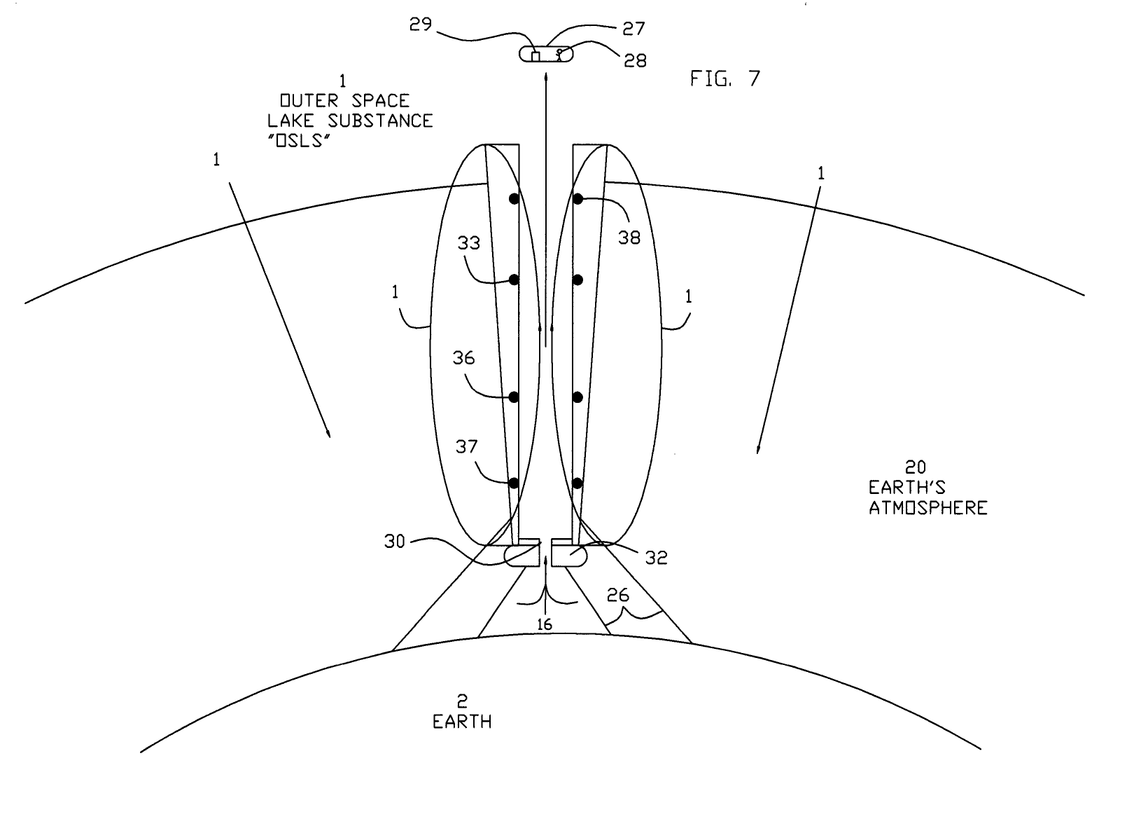

### DESCRIPTION OF PATENT PREFERED EMBODIMENT

Conventional thinking teaches that the Earth has a “gravitational pull” which “pulls” objects toward it. This conventional “gravitational pull” theory assumes the phenomena and ability to pull or attract a tangible object by an intangible attraction. It is taught that to move a tangible object upward (being the direction opposite the center of the earth), this gravitational attraction must be overcome.

This invention does not assume or agree that there is a “gravitational pull” or attraction by the Earth. This invention asserts that “outer space is a lake of substance” and that the Earth, as well as other planets, consume the substance of the “outer space lake”. This invention asserts that what we conventionally perceive as “gravitational pull” is in fact a substance flowing at a velocity from an “outer space lake” toward the surface of the Earth.

This invention asserts that the “commonly referred to void of outer space” is in fact filled with a substance. This substance could be what we commonly refer to as electrons. Whatever the substance, it fills “the outer space void” like a lake of water. The planets consume this “outer space lake substance”. A current is caused by the flow of this “outer space lake substance” to the planets in a spherical direction. Each plant has its own characteristic consumption rate of the “O.S.L.S.”. Size and or physical material composition may be a factor in determining the consumption rate of the “O.S.L.S.” The planets may be access points for flow of the “O.S.L.S.” to another dimension, like a drain valve in a lake. What we perceive as planets may be debris from space which collect around the access point to another dimension like debris collects at a screen strainer placed on a drain valve. A spherical flow to each planet creates a flow disturbance in the lake of “O.S.L.S.” Planets consumption of “OSLS” creates a vortex flow in the outer space lake.

Any substance or debris caught in the flow will be pushed along with the flow to the planets. We call this phenomena “gravity” as the “O.S.L.S.” contacts the mass physical surface of the planets it is partially diverted and flows along the surface to a point closer to the center of the consumption of the “O.S.L.S.” which may be the center of the earth, or the point of access to another dimension which is located below the surface of the planet. The diverted flow of “O.S.L.S.” along with the surface of the planet to a point closer to its center is what is “commonly known as gravity pulling an object down hill”. An item moves “down hill” because it is pushed in a flow of “O.S.L.S.”

Physical substances change phase into light when sufficient energy is applied. The light is emitted and may flow counter to the flow of “O.S.L.S.” without effect.

The sun emits light which travels through the “O.S.L.S.”. The light slows when it contacts mass density and release energy in the form of heat and returns to mass moving at a high velocity. This reduced light mass impacts the planets and creates a force to push a planet away from the source of the light such as the sun light pushes the earth away from it and the “O.S.L.S.” consumption by the sun creates a flow to pull the earth to the sun. A balance of these forces create an orbit distance between the sun and earth. The moon obstruct the flow of“O.S.L.S.” slowing in the moons shadow or path. The pressure on the Earth's surface beneath the moon is less, therefore the greater force beyond the moon shadow produces greater Earth surface density and accounts for why the oceans are pushed in the direction of the moon.

The “outer space lake substance” approaches the surface of the Earth from a spherical direction. The area and volume of a given diameter sphere decreases as the diameter decreases.

An object free falling to Earth's surface is measured to fall at a rate of 32 feet per second near the earth surface. This rate of movement is not due to the object being “pulled by gravity”; it is however, due to the object being moved in a flow stream of “outer space lake substance” which has a velocity of 32 feet per second as it flows toward the Earth in a spherical direction. As “the outer space lake substance” flows to Earth the consumable volume compresses, thus increasing density, weight and temperature.

Density increases because a given quantity of substance is contained in a smaller spherical volume and weight increases for the same reason. Temperature increases due to the energy released due to compaction and increased density absorption of sun energy as measured to be approximately one degree warmer per 1,000 feet closer to the Earth's surface. The velocity of the “outer space lake substance” flow to the Earth increases as it approaches the Earth. The increase in velocity is proportional to the ratio of sphere volume as the diameter of the sphere decreases. Inversely, the velocity decreases with distance from the Earth's surface as perceived as weightlessness in outer space, which is equivalent to zero velocity of the “outer space lake substance”.

The present invention is based on reversed velocity direction using a conduit. The atmospheric pressure and weight are increased at the surface of the Earth.

A first end of a conduit is placed in proximity to the surface of the Earth and a second end of said conduit is placed in proximity to the Earth's upper atmosphere or outer space, which are less dense and lightweight.

The greater atmosphere weight and pressure at the first end near the Earth will force air up the conduit to the lighter less dense atmosphere at the second end of said conduit, thus creating an upward velocity of air up the conduit. This velocity force of upward air movement may be used to propel or carry in it persons and/or items wished to be carried to a second end of said conduit. The velocity of air movement up the conduit may also be used to propel persons and/or items to distances beyond the second end of the conduit. In other words, the conduit may be utilized like a cannon to shoot items into space.

Valving arrangements may be placed on the first end of the conduit to control velocity, volume, pressure, density, and movement. Valving arrangements may be placed on the second end of the conduit to control velocity, volume, pressure, density and movement of the atmosphere persons and/or items.

Fans, compressors, blowers, lighter than air vessels, air locks, computers, controls, power supplies and/or personnel may be used to alter, manage or control velocity, volume, pressure, density, movement, and/or stability of the conduit, atmosphere, persons or items.

Computers, controls, air locks, power supplies, foundations, lighter than air vessels, boats, ships, moring line and/or personnel may be used to locate in position, maintain position, and/or alter orientation.

Altered valving and control arrangements will allow the upward velocity of air to reduce or stop in order to allow personnel and/or items to be lowered through the conduit from the second end to the first end.

A gentle decent may be arranged by balancing between the upward velocity of air forced up said conduit against the downward velocity of the “outer space lake substance”. Said conduit operates similar to that of a chimney.

Said conduit uses similar principles to that of hydraulics. The greater area and pressure of Earth's surface atmospheric weight and pressure are the force to move air up a cylinder, which has a lower pressure and density at the top, thus a significant differential pressure is established between the Earth, first end of said conduit and the outer space second end of said conduit. Matter flows from greater density and greater pressure to areas of lesser density and lesser pressure.

Atmospheric weather, winds, and storms are a hazard to maintaining a substantially long conduit starting in proximity to the Earth's surface and reaching in proximity to Earth's upper atmosphere. This invention relates to means to anchor, locate in place, and secure for use a conduit having a location on earth with minimal winds and storms.

The conduit may have thrusters located along its length to sense and balance against winds. Wings or sails may be used to balance wind currents against themselves.

Lighter than air vessels may be located along the length of the conduit to support and stabilize the conduit. The conduit may have an inner and outer liner with lighter than air gases between the liners to lift, support and secure the conduit. Magnetic fields may be established to support and secure the conduit. One or more Earth orbiting satellites may be placed in proximity to and attached to the upper second end of the conduit to.

The lower first end of the conduit may be tethered and secured at a reasonable distance above the Earth's surface to minimize the adverse effect of surface weather. A service platform may be secured to the lower end of the conduit. A lighter than air platform may be used at the first end of the conduit and it may have a refuel able or thrust-supported platform accessible as needed by aircraft.

The lower first end may be anchored, supported and/or accessed by a ship or oil drilling rig type system. An inflatable conduit may be anchored to a ship or oil device in a calm ocean part of the world. The conduit may be inflated with lighter than air gas and raised into place for use or deflated and lowered to float until used again. The similar concept may be applied on land.

The “outer space lake of substance” is not a vacuum, void of substance. If no substance exists in outer space then it would not be possible to transmit radio impulses through space.

The “outer space lake substance” is consumed by the Earth at a rate of 1,218,555 cubic miles per second as calculated by the velocity of 32 feet per second or 0.0061 miles per second times the area of the Earth which is 201,061,929 square miles.

The “OSLS” bombards the Earth's surface from all spherical sides as light is deflected when it hits a high molecular surface such as water or crystal so also “OSLS” is deflected when it hits the Earth's surface. The “OSLS” which is not consumed by the Earth is redirected by heavy metals, which function as conduits. The deflected “OSLS” sets up what we commonly refer to as a magnetic field and causes a rotation of the Earth and also propels the Earth through the “OSLS”. The angle of the magnetic field in relation to the Earth's rotational mass propels the Earth in an elliptical orbit. The force of the sun's light energy pushes on the Earth thus setting the Earth's distance from the sun.

A mile long plumb bob test down two-mile deep mining shafts conducted quietly by both France and the USA around 1900 did fail to support the theory of “gravitational pull” to the center of the Earth. In fact, they proved just the opposite. The two plumb bob lines were not closer together at the bottom as expected to prove the “gravitational pull theory”. The two plumb bob lines were in fact over 8 inches further apart at the bottom thus illustrating that the weights at the bottom of the plumb bobs were not “pulled” to the center of the Earth but were rather pushed by the flow of “OSLS” which deflects at the Earth's surface and sets up what we refer to as a magnetic field.

Electrical generators do not generate electricity but only redirect the flow of Earth's incoming “OSLS” by rotating a magnet, which is a specific molecular composition highly efficient at deflecting “OSLS”

As the Earth and a magnet and a “electric generate” redirect the flow direction of “OSLS” so this invention proposes a means to provide a conduit as described above having magnetic force fields to redirect the “OSLS” upward within the conduit. The upward (being opposite the direction to the center of the Earth) movement of the “OSLS” (magnetic force field) would carry persons and/or items in the stream velocity flow of “OSLS” to the outer space end of the conduit.

### DEFINITIONS

1—Substance which fills outer space and which is consumed by Earth and other planets.

2—Earth

3—The volume of atmosphere existing between 10,000 feet above Earth's surface.

4—The volume of atmosphere existing between 10,000 feet above Earth's surface and 20,000 feet above Earth's surface.

5—The volume of atmosphere existing between 20,000 feet above Earth's surface and 30,000 feet above Earth's surface.

6—Earth's magnetic field

7—Earth's North pole

8—Earth's South pole

9—Rate of speed Earth's surface rotates at being approximately 1,050 miles per hour.

10—Earth's moon

11—The moon's orbit path around Earth

12—The Sun

13—Light energy leaving the Sun

14—Earth's orbit around the Sun

15—Patented conduit reaching from the proximity of Earth's surface up into Earth's atmosphere a predetermined length.

16—Atmospheric air moving into conduit 15 from a first end being in proximity to Earth's surface.

17—Atmospheric air exiting a second end of conduit 15 being located in or above Earth's upper atmosphere.

18—Shadow of moon. The moon blocks and reduces the flow of “O.S.L.S.” to earth.

19—Ocean—The ocean moves to the area of lower pressure. The moon obstructs the flow of“O.S.L.S.”. Flow to the earth thus the pressure in the “O.S.L.S.” shadow of the moon is lower, therefore the ocean is pushed toward the “O.S.L.S.” shadow of the moon.

20—Earths atmosphere

21—Secondary outer wall around the conduit is

22—Inflatable area between the conduit is and the secondary outer wall 21 creates a lighter than air chamber.

23—Thrust stabilizer

24—Aerodynamic stabilizer

25—Directional stabilizer.

26—Mooring line used to secure the conduit is to the earth, foundation or ship.

27—Mobile vehicle

28—Personnel

29—Object to be moved into space

30—Inlet throttling valve to allow atmospheric air to be pushed into the lower first end of conduit 15.

31—Outlet valve to release pressure at the upper 2^{nd} end of conduit 15.

32—Lighter than air vessel platform

33—Magnetic field generated to redirect the flow direction of “O.S.L.S.” The redirected “O.S.L.S.” assist to move the mobile vehicle 27 up or down the conduit along with the contents of the mobile vehicle 27.

34—Throttle Valve

35—Seals

What is claimed:

1. A conduit means having a first-end located in proximity to the earth's surface and a second-end located in proximity to outer space.

2. The method as claimed in claim 1, having at least one inlet throttling valve.

3. The method in claim 1, having a plurality of valves.

4. The method in claim 1 having a lighter than air means to support the conduit.

5. The method in claim 1 having a powered means to support the conduit.

6. The method in claim 1 having a means to anchor the conduit to the earths surface.

7. The method in claim 1 having a means to stabilize the conduit against the forces of weather.

8. The method in claim 1, having a vessel disposed within the conduit and having an inlet valve to allow the atmospheric air to enter beneath the vessel in order to cause the vessel to move up the conduit.

9. The method in claim 1, wherein a person, or object may be transported up the conduit from the earth's surface into outer space.

10. The device in claim 1, having a vessel capable of carrying objects or personnel is disposed within the conduit and having an inlet valve to allow the atmospheric air to enter beneath the vessel in order to cause the vessel to move up the conduit, wherein a bypass valve is used to control the velocity at which the vessel moves up or down the conduit.

11. The device in claim 1 having a vessel capable of carrying objects or personnel, disposed within the conduit and having an inlet valve to allow the atmospheric air to enter beneath the vessel in order to cause the vessel to move up the conduit, and having an “OSLS” redirecting means or electron directing means or reverse gravity directing means utilized to assist movement of the vessel.

12. The device in claim 1, 2, 3, 4, 5, 6, 7, 8, 9, 10 or 11 wherein a space station is located in proximity to the second end of the conduit.
